(19) United States
(12) Patent Application Publication
(10) Pub. No.: US 2005/0259005 A1
(43) Pub. Date: Nov. 24, 2005

(54) Beam forming matrix-fed circular array system

(75) Inventors: Bing Chiang, Melbourne, FL (US); Michael James Lynch, Merritt Island, FL (US); Douglas H. Wood, Palm Bay, FL (US); Steven Jeffrey Goldberg, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/878,723

(22) Filed: Jun. 28, 2004

Related U.S. Application Data
(60) Provisional application No. 60/572,811, filed on May 20, 2004.

(51) Int. Cl. H01Q 3/22

(52) U.S. Cl. 342/373

(57) ABSTRACT

A matrix-fed circular array system includes a plurality of antennas, a plurality of azimuth matrices in communication with the antennas, and a plurality of elevation matrices in communication with the azimuth matrices. The array system forms M×N beams, where M is the number of azimuth beams, and N is the number of elevation beams. In another embodiment, through the use of a Shelton-Butler or Butler matrix which includes a plurality of hybrids, the system outputs omni-directional pancake-shaped radiation patterns that are isolated from each other when a communication signal is input into the system. In yet another embodiment, the system uses a beam forming network including two Shelton-Butler matrices. A first one of the Shelton-Butler matrices creates omni-directional pancake beams that are isolated from each other, and a second Shelton-Butler matrix creates multiple directive beams in an azimuth plane.

### CROSS REFERENCE TO RELATED APPLICATION(S)

This application claims priority from U.S. provisional application No. 60/572,811, filed May 20, 2004, which is incorporated by reference as if fully set forth.

### FIELD OF THE INVENTION

The present invention relates to the field of wireless communications. More specifically, the present invention relates to various antenna configurations and the formation of antenna radiation patterns used for transmitting and receiving signals.

### BACKGROUND

Multiple-Input Multiple-Output (MIMO) wireless systems establish radio links by utilizing multiple antennas in an intelligent manner at the receiver side and the transmitter side. The multiple antennas are closely spaced, but typically are not sufficiently isolated from each other to optimize the quality of communications. Conventional MIMO wireless systems have not addressed elevation multiple beam coverage.

FIG. 1 shows a single conventional omni antenna 105 with a single receiver 110. Signal and noise are collected by a single “pipe” output 115 of the omni antenna 105. The pipe may consist of waveguide, coax, microstrip, or the like. Thus, received information loses its directional information and becomes 1-D time sequenced data. The basic way to extract the signal is to process the gain of the signal such that its level exceeds the interference and noise. The advanced way is to use correlation techniques to extract the signal out of the interference and noise. The technique can be coding with self-correlation, or may employ a rake receiver.

In a multipath environment, the same signal may come from multiple directions with different time delays. When the waves enter the “pipe”, the signal the waves carry may add or subtract, depending on the relative phase between them. Therefore, the received signal is at the mercy of the environment, however, the antenna can contribute somewhat to improve the signal strength.

FIG. 2 shows a conventional scanning beam antenna-like subscriber-based smart antenna (SBSA) 200 which improves the system performance by approximately 3 dB. When a directive beam is formed, the radiation entering the beam near the peak is correlated, and that outside the beam is considered uncorrelated. When the beam is pointing to the signal, the power from the signal is in phase, and the field intensity adds vectorially. Noise, by definition, is uncorrelated, so the noise power adds in scalar. This gives the signal in the beam the directivity gain over noise. This is in addition to the processing gain seen in the omni antenna 105 of FIG. 1.

FIG. 3 shows multiple conventional single omni-antennas feeding multiple transceivers. A wireless MIMO system can have improvements of 10 to 20 dB. In an environment without multipath, all the antennas will receive similar signals and similar noise; being varied primarily by phase delays. When the signals from the different receivers are synchronized and summed, the noise is also to some degree synchronized and summed. The resultant signal is increased by the multitude of receivers, and at the same time the noise is also increased by about the same multiple. Thus, there is little or no net signal-to-noise (S/N) improvement in an environment without multipaths.

In a multipath environment, each antenna receives its signal through a different channel; which may be similar or drastically different. While the signals are synchronized and summed (equivalent to vector sum at RF), the noise, being statistically different from channel to channel, is summed without synchronization, (i.e., a scalar sum). The S/N is thus significantly improved. For example, if two channels with the same signal power and noise power are summed in this manner, the gain in S/N would be approximately 3 dB.

An antenna configuration is desired that addresses elevation multiple beam coverage and provides multiple antenna isolation.

### SUMMARY

The present invention provides various beam forming systems to enhance communications implemented using MIMO applications.

A received signal includes the characteristics of the antennas as well as the characteristics of the channel over which it was transmitted. Thus, if the antennas have different characteristics, the channels are accordingly different. Since radiation properties of an antenna are usually defined by both an amplitude pattern and a phase pattern. This leads to the conclusion that a significant change in phase pattern can also be as effective to MIMO as an amplitude pattern change.

In one embodiment, a matrix-fed circular array system includes a plurality of antennas which form a circular array, and a matrix in communication with the circular array. The matrix includes a plurality of hybrids. The system outputs omni-directional pancake-shaped radiation patterns that are isolated from each other when a communication signal is input into the system.

The matrix may be a Shelton-Butler matrix. The matrix-fed circular array system may further include a plurality of fixed phase shifters (e.g., line-lengths) in communication with the hybrid. The system may be used for MIMO applications.

In another embodiment, a matrix-fed circular array system includes a plurality of antennas which form a circular array, a plurality of azimuth matrices in communication with the circular array, and a plurality of elevation matrices in communication with the azimuth matrices. The array system forms M×N beams, where M is the number of azimuth beams, and N is the number of elevation beams.

The elevation matrices may be of a Shelton-Butler or Butler matrix configuration.

In yet another embodiment, a beam forming matrix-fed circular array system includes a circular array including a plurality of antennas, and a beam forming network. The network includes a first Shelton-Butler matrix in communication with the circular array for creating omni-directional pancake beams that are isolated from each other, and a second Shelton-Butler matrix in communication with the first matrix for creating multiple directive beams in an azimuth plane.

A cross-over point, formed by two intersecting directive beams formed by the azimuth system, has a power level that is three decibels below the level of the peaks of the beams. The directive beams are formed by summing orthogonal omni-directional modes that are related to each other as elements in a Fast Fourier sequence.

### BRIEF DESCRIPTION OF THE DRAWINGS

A more detailed understanding of the invention may be had from the following description, given by way of example and to be understood in conjunction with the accompanying drawings wherein:

FIG. 1 shows that a conventional single omni antenna;

FIG. 2 shows a conventional scanning beam antenna;

FIG. 3 shows multiple conventional single antennas feeding multiple receivers;

FIG. 4A shows a Shelton-Butler matrix;

FIG. 4B shows a circular array fed by the matrix of FIG. 4A;

FIGS. 5A, 5B, 5C and 5D show the various orthogonal omni-directional modes that can be formed by a Shelton-Butler matrix-fed circular array;

FIGS. 6, 7, 8A and 8B show how a spatial null can be avoided when using various orthogonal omni-directional modes;

FIG. 9A shows a two-tier stacked matrix;

FIG. 9B shows a stacked circular array that can be fed by the stacked matrix of FIG. 9A;

FIG. 9C shows a simplified two-tier stacked circular array;

FIG. 9D shows a simplified feeding structure that can be used in a two-tier elevation structure;

FIG. 10 illustrates radiation patterns depicting conical beams covering different elevation angles;

FIG. 11 shows six azimuth beam patterns available from a multiple beam antenna;

FIG. 12 shows antenna beam cross-over points at 30 degrees from peak;

FIG. 13 shows radial scale change to enhance beam peaks;

FIG. 14 shows a matrix-fed circular array with beam forming network in accordance with another embodiment of the present invention;

FIG. 15 shows an azimuth/elevation beam matrix configured in accordance with a preferred embodiment of the present invention; and

FIG. 16 shows radiation patterns depicting eight beams, four in the upper tier and four in the lower tier where one is blocked by the ones in the front.

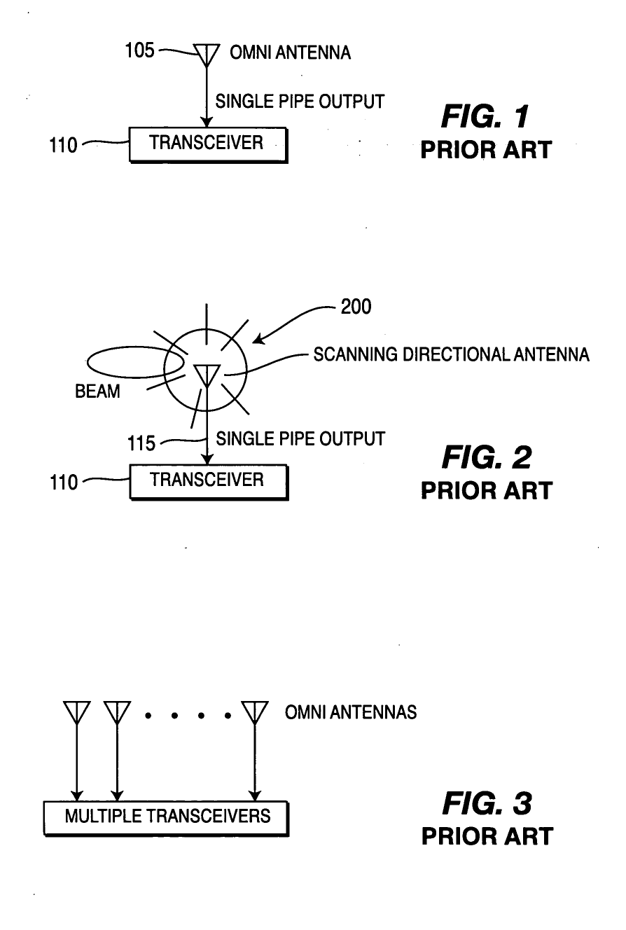

### DETAILED DESCRIPTION OF THE PREFERRED EMBODIMENT(S)

The preferred embodiments will be described with reference to the drawing figures where like numerals represent like elements throughout.

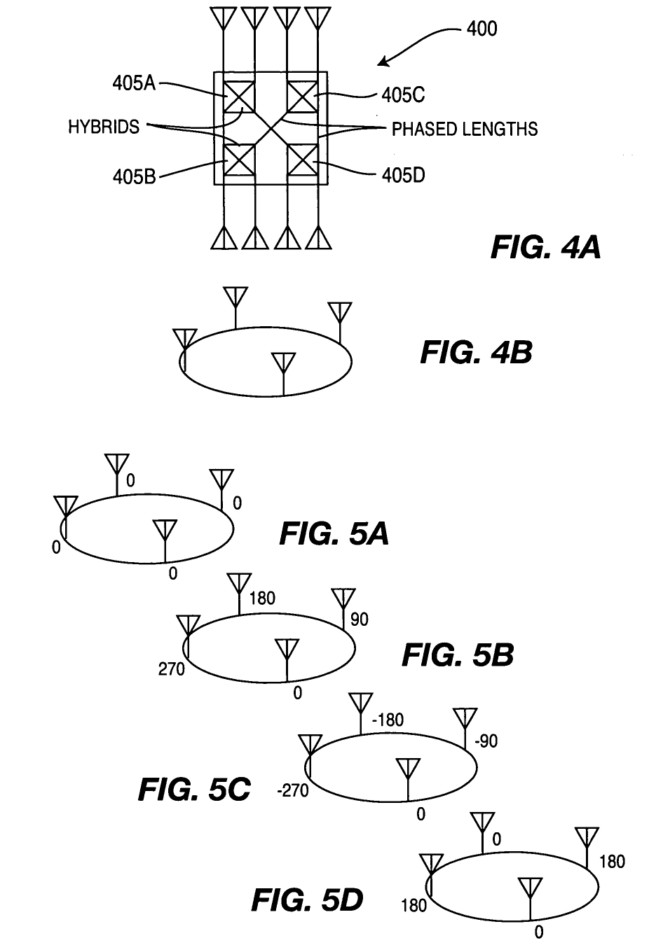

FIG. 4 shows a Shelton-Butler matrix 400 which forms omni-directional pancake-shaped radiation patterns. The wave on the plane parallel to ground can provide phasing that narrows the elevation beamwidth, similar to that found in a surface wave structure like a Yagi array. The matrix can also be devices that have the same distribution characteristic, (e.g., a Rotman Lens).

Matrix 400 consists of hybrids 405A, 405B, 405C, 405D, and fixed phase shifters which can be line-lengths (not shown for clarity). A 4 port matrix is shown, but it can be 2 ports, 3 ports, 4 ports, 6 ports, etc.

FIG. 4B shows a circular array that can be fed by the matrix 400 shown in FIG. 4A. The antenna elements can consist of just about any type with any polarization.

FIGS. 5A, 5B, 5C and 5D show the various orthogonal omni-directional modes that can be formed by a Shelton-Butler matrix-fed circular array. The orthogonality preserves the full strength of each mode, which is in contrast to mode formation using a power-divider, where the power not used in forming the one mode is lost in the division process.

Each mode has its characteristic phase set. Together, they form a closed set. It has been shown that this set has the same characteristics of a Fast Fourier transform set in that they form an orthogonal set, the components of which are completely isolated. In practice, the degree of isolation is limited by the hybrids that build up the matrix.

FIGS. 6, 7, 8A and 8B show how a spatial null can be avoided when using the modes. Additionally, because of the difference in the phasing of each mode, the channel characteristic is different for each mode, so this system can be used by MIMO to improve system gain through channel diversity. There are N modes in an N-element matrix-fed circular array. Each mode is designated by its phase progression.

FIG. 6 is a zero mode, where all elements are fed in-phase. Two oppositely traveling waves of the same strength may enter the array and end up with zero signals if the two waves have opposite phases.

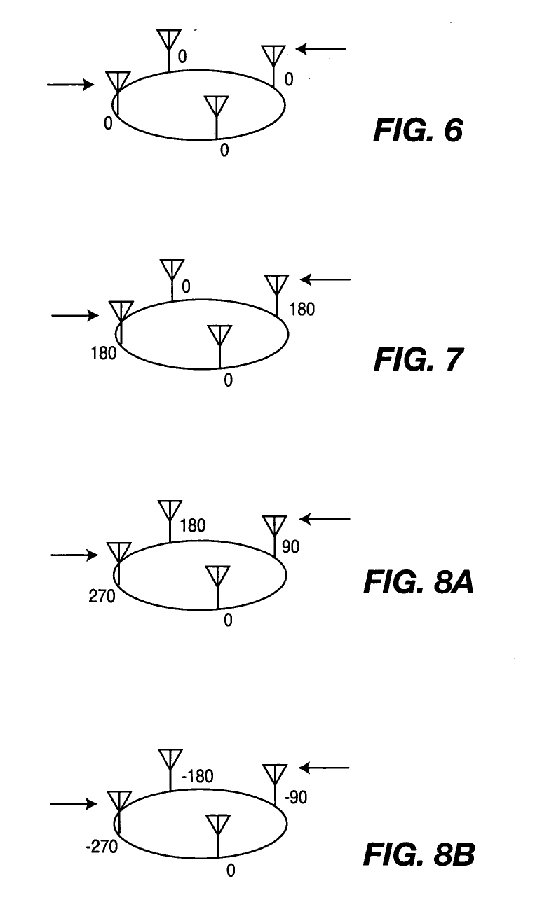

FIG. 7 is a “180 deg.” mode and has the same wave cancellation as shown in FIG. 6, but it has a different phase angle, if the cancellation is not a total cancellation. Furthermore, if the two waves are rotated about the center of the array, the phase can take on different values.

FIG. 8A is the “90 deg.” mode. The same two opposites traveling waves enter the array will experience signal addition. FIG. 8B is a “−90 deg” mode, which will also experience signal addition, but carries a phase reversal from FIG. 8A, which makes them distinct from each other. This series illustrates that if one mode experiences cancellation, at least two others will not, and result of all modes is unique. In a multipath-rich environment, the two modes carry dissimilar sets of information, and can be sorted out by the processor.

In summary, the proposed antenna system provides multiple omni-directional modes that do not interact with each other. Each mode is realized by looking into a given mode port of the matrix. All elements are used to form each mode, so we have an aperture-reuse advantage, which forms a narrower elevation beam.

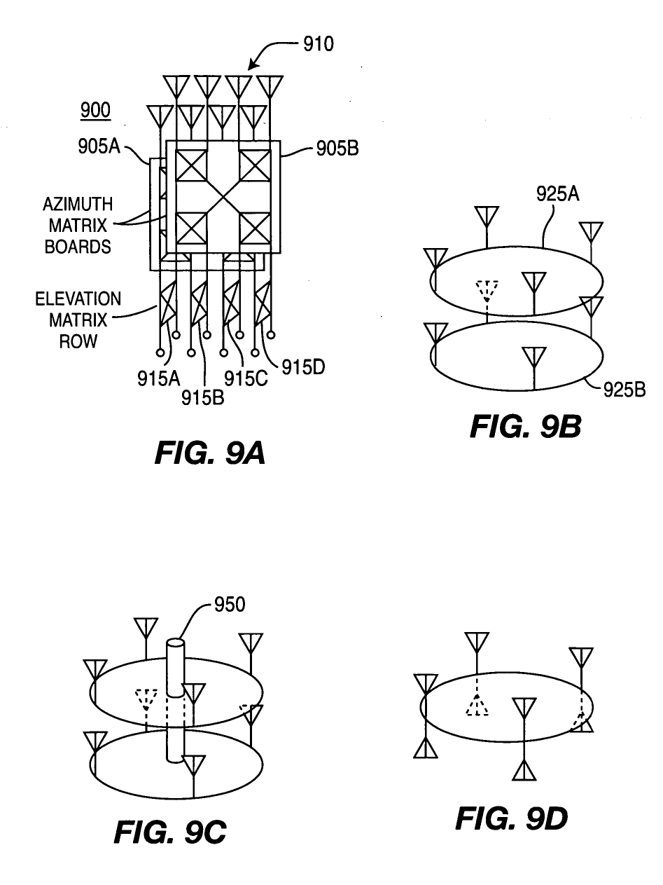

In another embodiment, as shown in FIG. 9A, a row of elevation Butler matrices are used to feed two or more stacked circular arrays 925A, 925B, as shown in FIG. 9B, to create isolated narrow-width elevation beams. In FIG. 9C, a reflector rod 950 placed in the array center can facilitate the feeding of the upper array. A simplified feeding array as shown in FIG. 9D can be used for a two-tier elevation structure.

FIG. 9A shows a two-tiered beam forming matrix-fed circular array system 900 including at least two azimuth matrix boards (i.e., matrices) 905A, 905B, feeding eight antennas 910. The azimuth matrix boards 905A, 905B, are in turn fed by a row of elevation matrices 915A, 915B, 915C, 915D, which separate the family of azimuth beams into two families with different elevation angles. In this case, each elevation matrix is a two-port hybrid with proper phase delays.

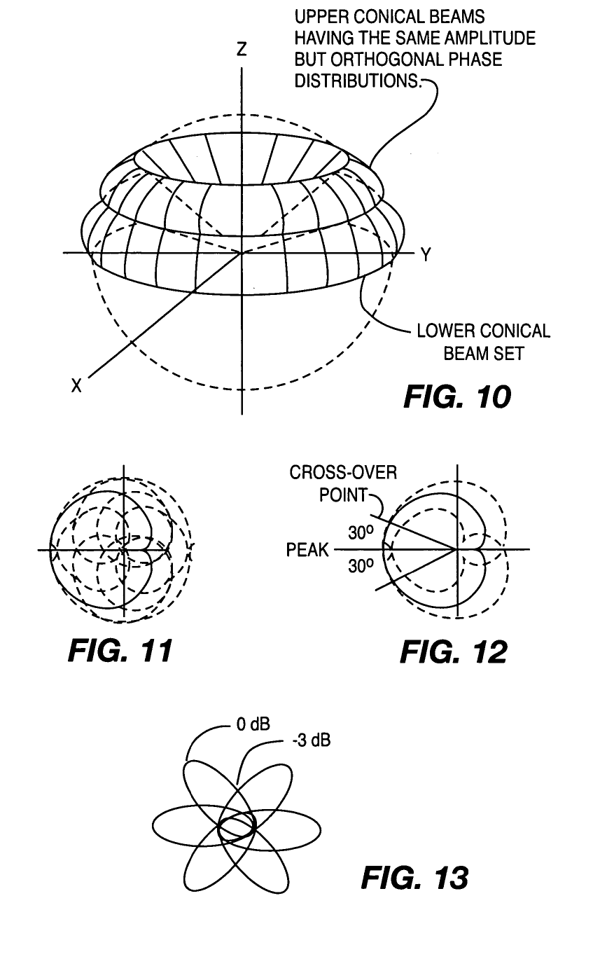

As depicted in FIG. 10, when each circular array is fed by an azimuth Shelton-Butler matrix, the beams formed in the azimuth plane by system 900 are pancake or conical shaped so as to create multiple isolated omni-directional pancake or conical-shaped beams that are isolated from each other. Radiation patterns depicting conical beams cover different elevation angles. Each beam is in fact a set of conical beams with harmonic phase distributions. The beam stacking comes from the elevation matrices 915A, 915B, 915C, 915D.

FIG. 11 shows the azimuth patterns created by two systems 400, shown in FIG. 4, connected in tandem to provide multiple simultaneous directive beams for MIMO. A plurality of highly directive beams (e.g., six beams) is formed by utilizing the whole aperture, in contrast to just the aperture of a single element. The first system 400 is the equivalent of a Fast Fourier Transformer, and the second system 400 is the equivalent of an Inverse Fast Fourier Transformer

FIG. 12 shows another useful property of the tandem system 400, whereby the power level of the cross-over point, where two adjacent beams intersect, is approximately 3 dB below the beam peaks.

FIG. 13 shows that the 3-dB cross-over point of FIG. 12 is possible since the directive beams are formed by summing orthogonal omni-directional modes that are related to each other as elements in a Fast Fourier sequence. The harmonic series, when summed, provides the 3-dB cross-over point.

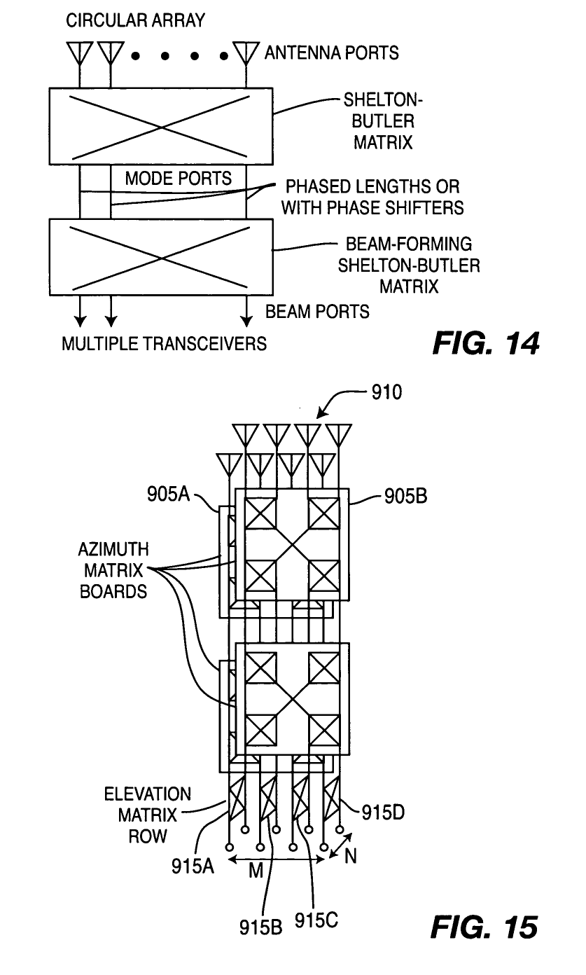

FIG. 14 shows a Shelton-Butler matrix-fed circular array system having characteristics depicted by FIGS. 11-13, which provides the highly isolated and highly directive beams needed by MIMO to create highly distinct communication channels. The 3-dB cross-over provides each beam with its maximum separation without giving up signal content since, at the 3-dB cross-over point, each beam shares equal signal content. Conversely, at the cross-over point, the sum of the signal power from each of the two beams adds up to unity.

As depicted in FIG. 15, the azimuth matrix boards 905A, 905B, are of Shelton-Butler configuration. When each circular array is fed by two Shelton-Butler matrices in tandem, pencil beams are formed. The elevation matrix rows 915A, 915B, 915C, 915D, can be of Butler or Shelton-Butler configuration. The pencil beams are first formed in vertical stacks, like spread fingers on a hand, each having a different elevation angle. Additionally, they are also formed in side-by-side columns, covering 360 degrees in azimuth, as depicted by FIG. 11. The azimuth beam distribution has 3-dB crossover points. The elevation beams can be designed to have different crossover values. In this full-up configuration, the total number of beams is M×N, where M is the number of ports in the Shelton-Butler matrix, forming M azimuth beams, and N is the number of ports in the Butler matrix, forming N elevation beams. The matrix is thus a 2-D matrix. Any subset of the beams can be used, simply by selecting only the corresponding ports to feed.

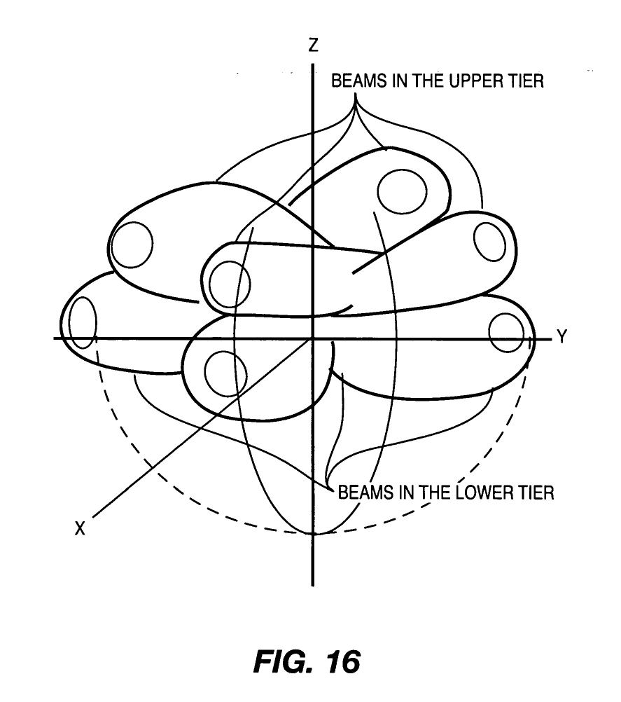

FIG. 16 shows radiation patterns depicting eight beams, four in the upper tier and four in the lower tier, (where one is blocked by the beams in the front). Each beam points in a different direction, and is formed by all the antenna elements working together. The concept employs aperture reuse to form narrow beams, along with simultaneous beams ideal for MIMO.

The 2-D Butler matrix-fed circular array stack provides a set of highly isolated beams which literarily cover the whole sphere. The beams are needed by MIMO to create highly distinct multiple communication channels, not only in azimuth, but also in elevation. Additionally, if the design should choose to form 3-dB crossover points in elevation, it will provide each beam with its maximum elevation separation without giving up signal content since the 3-dB crossover point, each beam shares equal signal content. Conversely, at the crossover point, the sum of the signal power from each of the two beams adds up to unity. Each beam can also be used individually, by simply feeding or switching-on one port at a time. Through port selection, beam direction can be electronically changed.

While the present invention has been described in terms of the preferred embodiments, other variations which are within the scope of the invention as outlined in the claims below will be apparent to those skilled in the art.

1. A matrix-fed circular array system comprising:
(a) a plurality of antennas which form a circular array; and
(b) a first matrix in communication with the circular array, the first matrix including a plurality of hybrids, wherein the system outputs omni-directional pancake-shaped radiation patterns that are isolated from each other when a communication signal is input into the system.

2. The matrix-fed circular array system of claim 1 wherein the first matrix is of a Shelton-Butler matrix configuration.

3. The matrix-fed circular array system of claim 1 further comprising:
(c) a plurality of fixed phase shifters in communication with the hybrids.

4. The matrix-fed circular array system of claim 3 wherein the fixed phase shifters are line-lengths.

5. The matrix-fed circular array system of claim 1 wherein the system is used for at least one multiple input multiple output (MIMO) application to enhance system gain through channel diversity.

6. A matrix-fed circular array system comprising:
(a) a plurality of antennas which form a circular array;
(b) a plurality of azimuth matrices in communication with the circular array; and
(c) a plurality of elevation matrices in communication with the azimuth matrices, wherein the array system forms M×N beams, where M is the number of azimuth beams, and N is the number of elevation beams.

7. The matrix-fed circular array system of claim 6 wherein the azimuth matrices are of a Shelton-Butler matrix configuration.

8. The matrix-fed circular array system of claim 6 wherein the elevation matrices are of a Shelton-Butler matrix configuration.

9. The matrix-fed circular array system of claim 6 wherein the elevation matrices are of a Butler matrix configuration.

10. The matrix-fed circular array system of claim 6 wherein a cross-over point, formed by two intersecting directive beams, has a power level that is approximately three decibels below the level of the peaks of the beams.

11. The matrix-fed circular array system of claim 10 wherein the directive beams are formed by summing orthogonal omni-directional modes that are related to each other as elements in a Fast Fourier sequence.

12. The matrix-fed circular array system of claim 6 wherein the system is used for at least one multiple input multiple output (MIMO) application to enhance system gain through channel diversity.

13. A beam forming matrix-fed circular array system comprising:
(a) a circular array including a plurality of antennas; and
(b) a beam forming network including:
(b1) a first Shelton-Butler matrix in communication with the circular array for creating omni-directional pancake beams that are isolated from each other; and
(b2) a second Shelton-Butler matrix in communication with the first matrix for creating multiple directive beams in an azimuth plane.

14. The beam forming matrix-fed circular array system of claim 13 wherein a cross-over point, formed by two intersecting directive beams, has a power level that is approximately three decibels below the level of the peaks of the beams.

15. The beam forming matrix-fed circular array system of claim 13 wherein the system is used for at least one multiple input multiple output (MIMO) application to enhance system gain through channel diversity.
